(19) United States
(12) Patent Application Publication
(10) Pub. No.: US 2011/0170026 A1
(43) Pub. Date: Jul. 14, 2011

(54) MULTI-FUNCTIONAL LIQUID CRYSTAL PARALLAX BARRIER DEVICE

(75) Inventor: MING-YEN LIN, Taipei City (TW)

(73) Assignee: UNIQUE INSTRUMENTS CO.LTD, Taipei City (TW)

(21) Appl. No.: 12/987,567

(22) Filed: Jan. 10, 2011

(30) Foreign Application Priority Data
Jan. 8, 2010 (TW) 099100423

(51) Int. Cl. G02F 1/1335

(52) U.S. Cl. 349/15

(57) ABSTRACT

A multi-functional liquid crystal parallax barrier device is a liquid crystal parallax barrier device mainly formed by two independent barrier electrodes, which are individually driven to achieve the purpose of displaying 3D images bi-directionally with different barrier structures and different numbers of views.

### BACKGROUND OF THE INVENTION

1. Field of Invention

The present invention relates to a multi-functional liquid crystal parallax barrier device, and more particularly to a liquid crystal parallax barrier device mainly formed by two independent barrier electrodes, which are individually driven to achieve the purpose of displaying 3D images along two directions, displaying 3D images with different barrier structures and with different numbers of views.

2. Related Art

FIG. 1 is a schematic view of consisting of a liquid crystal parallax barrier in the prior art. The conventional liquid crystal parallax barrier 50 mainly includes two linear polarizers 51, two transparent substrates 52 (for example, glass), a common electrode layer 53, a barrier electrode layer 56, two alignment layers 54, and a liquid crystal molecular layer 55. The liquid crystal molecular layer 55 is generally made of a TN liquid crystal material. The two linear polarizers 51 respectively have a light polarized direction and are perpendicular to each other. The common electrode layer 53 and the barrier electrode layer 56 are transparent electrodes (referred to as electrodes for short hereinafter) formed by ITO. The electrode structure of the barrier electrode layer 56 is formed by a barrier structure including a vertical strip parallax barrier, a slant-and-strip parallax barrier, or a slant-and-step parallax barrier, and the above barrier structure may achieve the purpose of displaying a multi-view 3D image. The consisting of the liquid crystal parallax barrier in the prior art may refer to U.S. Pat. No. 5,315,377. The principles of the parallax barriers, the designs and optical functions of the parallax barrier structures, and the construction of the multi-view 3D image may refer to the paper “Theory of Parallax Barriers”, Sam H. Kaplan, Vol. 59, Journal of the SMPTE, 1952, and refer to ROC Patent Application No. 097135421, No. 098113625, and No. 098128986 in details. Hereinafter, for the simplicity of the drawings, the prior art and the efficacy of the present invention are illustrated with the structure of the vertical strip parallax barrier and the display of the double-view 3D image.

FIG. 2 is a schematic view of a vertical strip parallax barrier electrode structure. As shown in FIG. 2, a plurality of strip electrodes 57 is installed on the barrier electrode layer 56, and all the electrodes 57 are electrically connected and then connected to a power source 58. In addition, the common electrode layer 53 is a single electrode, and is also connected to the power source 58. The power source 58 may produce a proper driving voltage ν for controlling the optical function of the liquid crystal parallax barrier 50. Normally, when the liquid crystal molecular layer 55 is formed by the TN liquid crystal material, the driving voltage ν may be a square wave electrical signal having a proper amplitude and period.

When the voltage between every electrode 57 and the common electrode layer 53 is 0 (which is referred to as an OFF state of the liquid crystal parallax barrier hereinafter), as shown in FIG. 1, all liquid crystal molecules of the liquid crystal molecular layer 55 are in a spiral configuration, which allows all incident lights 59 to penetrate through the liquid crystal parallax barrier 50. Therefore, the liquid crystal parallax barrier 50 is in a transparent state.

Further, when a driving voltage ν is applied between each electrode 57 and the common electrode layer 53 (which is referred to as an ON state of the liquid crystal parallax barrier hereinafter), as shown in FIG. 3, the liquid crystal molecules between the electrode 57 and the common electrode layer 53 are in an upright configuration, which may achieve the effect of shielding the incident light 59 (in the following illustration, when the electrode structure is marked by the black color, it indicates that the electrode has the light shielding effect). Therefore, the liquid crystal parallax barrier 50 may achieve the vertical strip parallax barrier effect as shown in FIG. 4. That is to say, the electrodes 57 function as shielding elements of the parallax barrier, and the areas outside the electrode structures 57 are regarded as light-transmissive elements of the parallax barrier. Therefore, under the control of the external driving voltage, the conventional liquid crystal parallax barrier may achieve a 2D/3D switching effect.

FIG. 5 is a schematic view of construction of a liquid crystal parallax barrier for 3D image display. As shown in FIG. 5, for a double-view combined image V_{L}+V_{R} displayed on a flat panel display screen 60, the liquid crystal parallax barrier 50 in the ON state may perform view separation on the double-view combined image (V_{L}+V_{R}) at several optimal viewing positions P_{L}, P_{R} (two optimal viewing positions are shown in the figure) on an optimal viewing distance Z₀. Therefore, at the optimal viewing positions P_{L}, P_{R}, single-view images V_{L}, V_{R} are respectively presented. In addition, the plurality of optimal viewing positions is distributed in a transverse direction (i.e., the X-axis direction) and a distance L_{V} between any two optimal viewing positions is set to be the interpupillary distance (IPD). Therefore, when eyes 61, 62 of the viewer are at positions P_{L}, P_{R}, the viewer can observe the 3D image. Since the liquid crystal parallax barrier 50 is disposed and fixed on the flat panel display screen 60, when the flat panel display screen 60 rotates by 90°, the plurality of optimal viewing positions P_{L}, P_{R} rotates by 90° accordingly, that is, the plurality of optimal viewing positions P_{L}, P_{R} is distributed in a longitudinal direction (i.e., the Y-axis direction). Therefore, eyes of the viewer have to rotate by 90° accordingly, or otherwise the viewer cannot observe the correct 3D image. As such, the liquid crystal parallax barrier in the prior art cannot achieve the bi-directional 3D image display effect.

Further, since the electrode 57 on the barrier electrode layer 56 is a fixed electrode structure, the 3D image display effect with different barrier structures or with different numbers of views cannot be achieved. That is to say, when the electrode 57 is designed to be a vertical strip parallax barrier, the electrode 57 cannot be switched into the slant-and-strip parallax barrier structure or the slant-and-step parallax barrier structure. In addition, when the electrode 57 is designed for the double-view 3D image display, the electrode 57 cannot be switched to display the multi-view 3D image with other numbers of views. In view of the above, the liquid crystal parallax barrier 50 in the prior art only has a single 3D image display function.

The solution to the problem that the display screen cannot be rotated is firstly provided in the mobile phone of Hitachi Company (WOOO mobile H001). The mobile phone has a display screen capable of rotating by 90°, and the screen is installed with a liquid crystal parallax barrier capable of bi-directionally displaying a 3D image. The liquid crystal parallax barrier capable of bi-directionally displaying the 3D image has a structure similar to the liquid crystal parallax barrier in the prior art, but has a difference concerning the structures of the common electrode and the barrier electrode layer.

As shown in FIG. 6, the original barrier electrode layer and common electrode layer are respectively installed with a plurality of longitudinal electrodes Bⁱ_{ν} (only B_{V}⁰ to B_{V}¹¹ are shown) and transverse electrodes B_{H}^{j} (only B_{H}⁰ to B_{H}⁹ are shown), where i, j are indices of the electrodes, the longitudinal direction refers to the Y-axis direction, and the transverse direction refers to the X-axis direction. The longitudinal electrode B_{V}ⁱ and the transverse electrode B_{H}^{j} have an orthogonal geometric relation. Compared with the conventional liquid crystal parallax barrier, to clearly illustrate the difference of the liquid crystal parallax barrier electrode structure capable of bi-directionally displaying the 3D image, the original barrier electrode layer is referred to as an upper barrier electrode layer 66, and the original common electrode layer is referred to as a lower barrier electrode layer 63 hereinafter. The upper and lower relation is only intended to facilitate illustration and is not intended to particularly limit the relation of the upper and lower devices.

In addition, the electrical connection of the electrodes has the following characteristics. The even numbered longitudinal electrodes B_{V}⁰ ˜B_{V}¹⁰ (referred to as longitudinal even electrodes hereinafter) are electrically connected and then connected to a power source 70 (referred to as a longitudinal even power source hereinafter). The odd-numbered longitudinal electrodes B_{V}¹˜B_{V}¹¹ (referred to as longitudinal odd electrodes hereinafter) are electrically connected and then connected to a power source 71 (referred to as a longitudinal odd power source hereinafter). The even-numbered transverse electrodes B_{H}⁰˜B_{H}¹⁰ (referred to as transverse even electrodes hereinafter) are electrically connected and then connected to a power source 72 (referred to as a transverse even power source hereinafter). The odd numbered transverse electrodes B_{H}¹˜B_{H}¹¹ (referred to as transverse odd electrodes hereinafter) are electrically connected and then connected to a power source 73 (referred to as a transverse odd power source hereinafter). The longitudinal even power source 70, the longitudinal odd power source 71, the transverse even electrode 72, and the transverse odd power source 73 respectively output a driving voltage ν_{V}^{e}, ν_{V}, ν_{H}^{e}, ν_{H}^{o}. Further, between every two longitudinal electrodes there exists a micro gap δ_{V} (referred to as a longitudinal electrode gap hereinafter) and between every two transverse electrodes there also exists a micro gap δ_{H} (referred to as a transverse electrode gap hereinafter), so as to avoid the electrical short circuit occurring between the odd electrodes and the even electrodes.

FIG. 7 is a schematic view of a longitudinal barrier generated by a liquid crystal parallax barrier capable of bi-directionally displaying a 3D image. As shown in FIG. 7, the driving voltages respectively output by the power sources 70, 71, 72, 73 are set to be ν_{V}^{e}=ν, ν_{V}^{o}=0, ν_{H}^{e}=0, ν_{H}^{o}=0. That is to say, the effect of the longitudinal barrier 80 may be generated by the drive of the longitudinal even electrodes Bᵥ⁰˜Bᵥ¹⁰ and setting the driving voltages of all the transverse electrodes to 0. Due to the existence of the transverse electrode gap δ_{H}, a state of no voltage driving exists between the longitudinal even electrodes Bᵥ⁰˜Bᵥ¹⁰ and the transverse electrode gap δ_{H}. Therefore, as shown in FIG. 8, on the longitudinal barrier 80 and at an overlapping position of the longitudinal even electrodes and the transverse electrode gap, the longitudinal barrier 80 is in a light-transmissive state. That is to say, different from the complete strip barrier generated by the liquid crystal parallax barrier in the prior art, the longitudinal barrier 80 has many light-transmissive gaps 81 with a width of δ_{H}.

FIG. 9 is a schematic view of a transverse barrier generated by a liquid crystal parallax barrier capable of bi-directionally displaying a 3D image. As shown in FIG. 9, the driving voltages respectively output by the power sources 70, 71, 72, 73 are set to be ν_{V}^{e}=0, ≡_{V}^{o}=0, ν_{H}^{e}=ν, ν_{H}^{o}=0. That is to say, the effect of the transverse barrier 90 may be generated by the drive of the transverse even electrodes B_{H}⁰˜B_{H}¹⁰ and setting the driving voltages of all the longitudinal electrodes to 0. Due to the existence of the longitudinal electrode gap δ_{V}, a state of no voltage driving exists between the transverse even electrodes B_{H}⁰˜B_{H}¹⁰ and the longitudinal electrode gap δ_{V}. Therefore, as shown in FIG. 10, on the transverse barrier 90 and at an overlapping position of the transverse even electrodes and the longitudinal electrode gap, the transverse barrier 90 is in a light-transmissive state. That is to say, different from the complete strip barrier generated by the liquid crystal parallax barrier in the prior art, the transverse barrier 90 has many light-transmissive gaps 91 with a width of δ_{V}.

In view of the above, although the liquid crystal parallax barrier capable of bi-directionally displaying the 3D image in the prior art may achieve the effect of bi-directionally displaying the 3D image, a complete common electrode layer cannot be provided, thus generating the light-transmissive gaps 81, 91 and causing the defects of light leakage through the gaps, so that the definition of the image is reduced, and the quality of the 3D image is lowered. In addition, the liquid crystal parallax barrier having the single function of 3D image display in the prior art lacks an independent common electrode, and thus the 3D image display effect with different barrier structures or different numbers of views cannot be presented.

### SUMMARY OF THE INVENTION

To solve the defects of the liquid crystal parallax barrier in the prior art, a multi-functional liquid crystal parallax barrier device of the present invention is a liquid crystal parallax barrier device formed by two independent barrier electrodes, which are individually driven to achieve the purpose of displaying 3D images along two directions, displaying 3D images with different barrier structures and with different numbers of views. Hereinafter, a solution is first proposed to solve the defect of light leakage through the gaps existing in the liquid crystal parallax barrier capable of bi-directionally displaying the 3D image in the prior art. Finally, it is illustrated that the present invention may achieve the 3D image display effect with different barrier structures and different numbers of views.

### BRIEF DESCRIPTION OF THE DRAWINGS

The present invention will become more fully understood from the detailed description given herein below for illustration only, and thus are not limitative of the present invention, and wherein:

FIG. 1 is a schematic view of consisting of a liquid crystal parallax barrier in the prior art;

FIG. 2 is a schematic view of a vertical strip parallax barrier electrode structure;

FIG. 3 is a schematic view of a shielding effect achieved by a liquid crystal parallax barrier;

FIG. 4 is a schematic view of a vertical strip parallax barrier effect achieved by a liquid crystal parallax barrier;

FIG. 5 is a schematic view of construction of a liquid crystal parallax barrier for 3D image display;

FIG. 6 is a schematic view of consisting of a longitudinal electrode and a transverse electrode;

FIG. 7 is a schematic view of a longitudinal barrier generated by a liquid crystal parallax barrier;

FIG. 8 is a schematic view of a light-transmissive gap in a transverse direction;

FIG. 9 is a schematic view of a transverse barrier generated by a liquid crystal parallax barrier;

FIG. 10 is a schematic view of a light-transmissive gap in a longitudinal direction;

FIG. 11 is a schematic view of consisting according to a first embodiment of the present invention;

FIG. 12 is a schematic view of consisting of an upper barrier electrode layer and a lower barrier electrode layer;

FIG. 13 and FIG. 16 are schematic views of generating a longitudinal barrier;

FIG. 14 and FIG. 17 are schematic views of generating a transverse barrier;

FIG. 15 is a schematic view of consisting according to a second embodiment of the present invention;

FIG. 18 to FIG. 20 are schematic views of an upper barrier electrode layer and a lower barrier electrode layer respectively installed with different parallax barrier structures; and

FIG. 21 is a schematic view of an upper barrier electrode layer and a lower barrier electrode layer respectively installed with a barrier structure having different numbers of views.

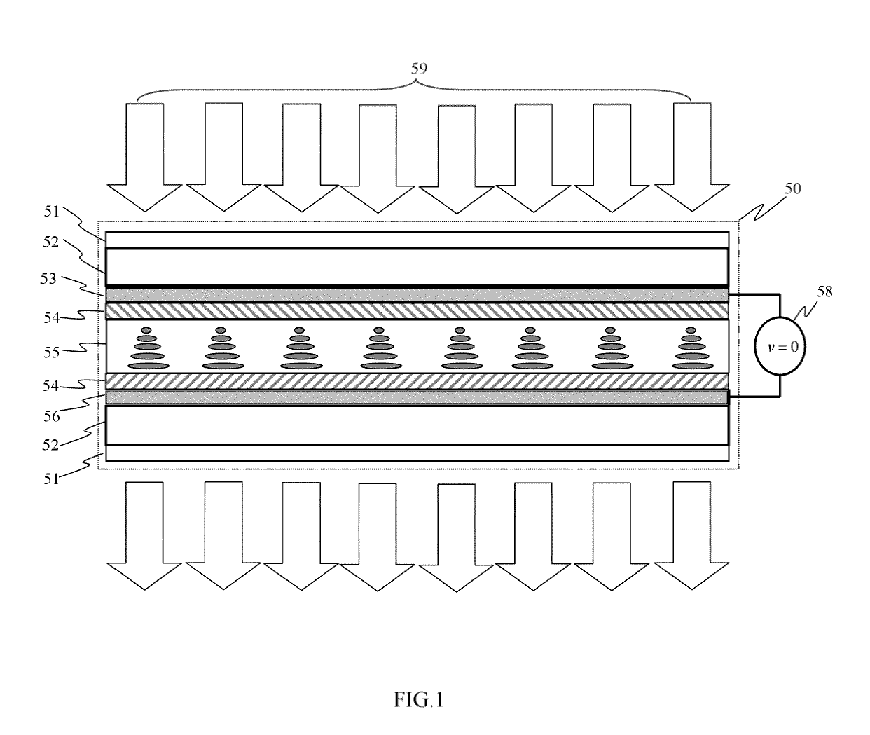

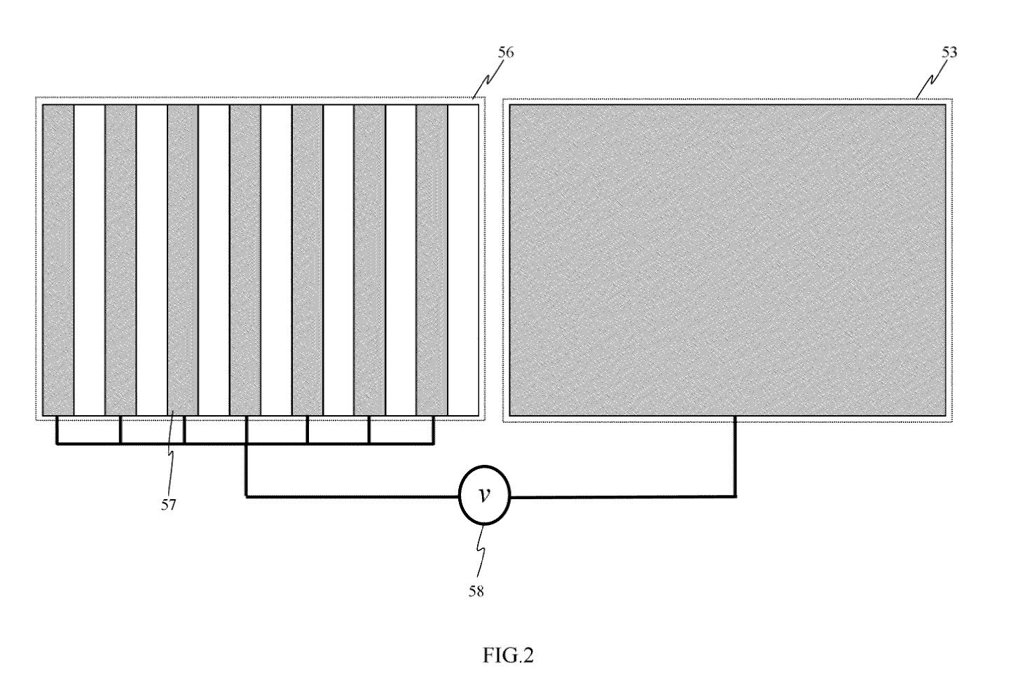

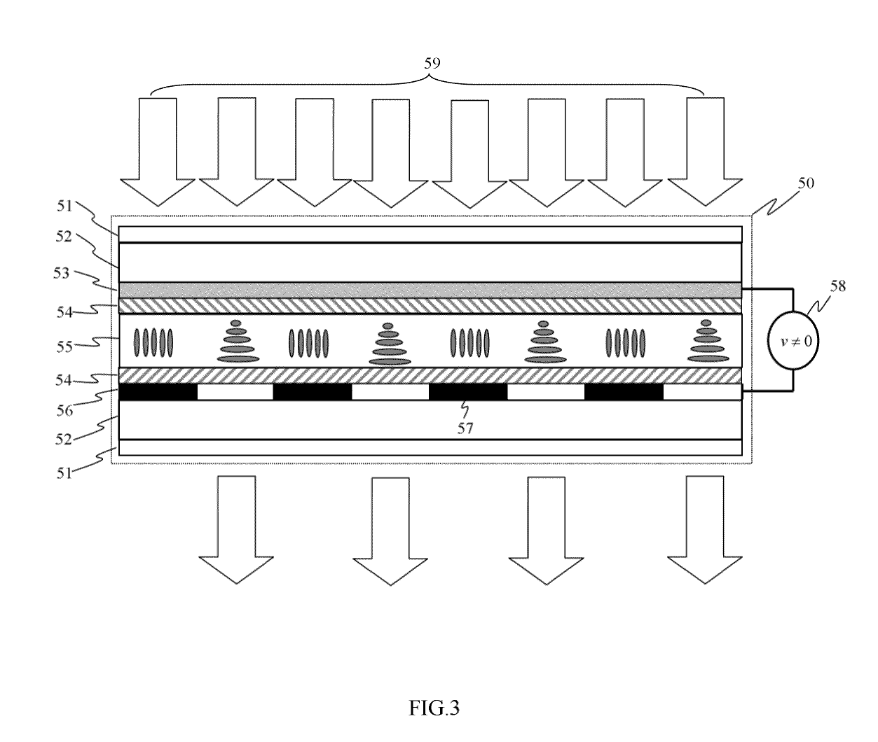

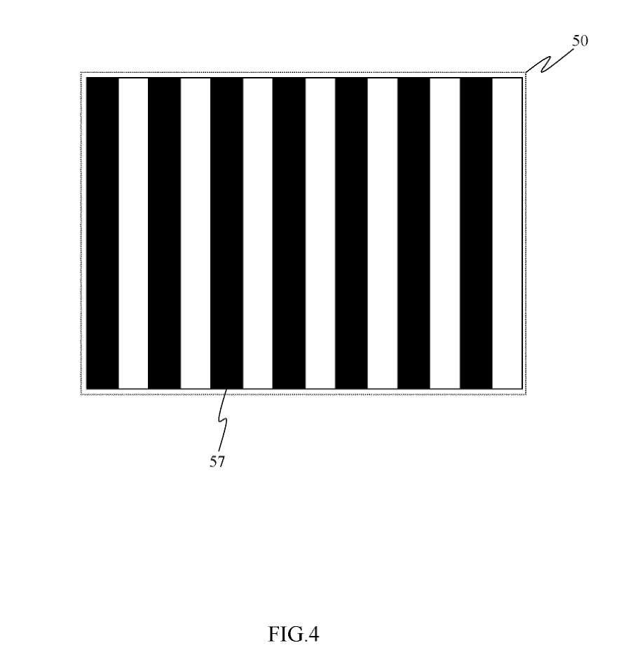

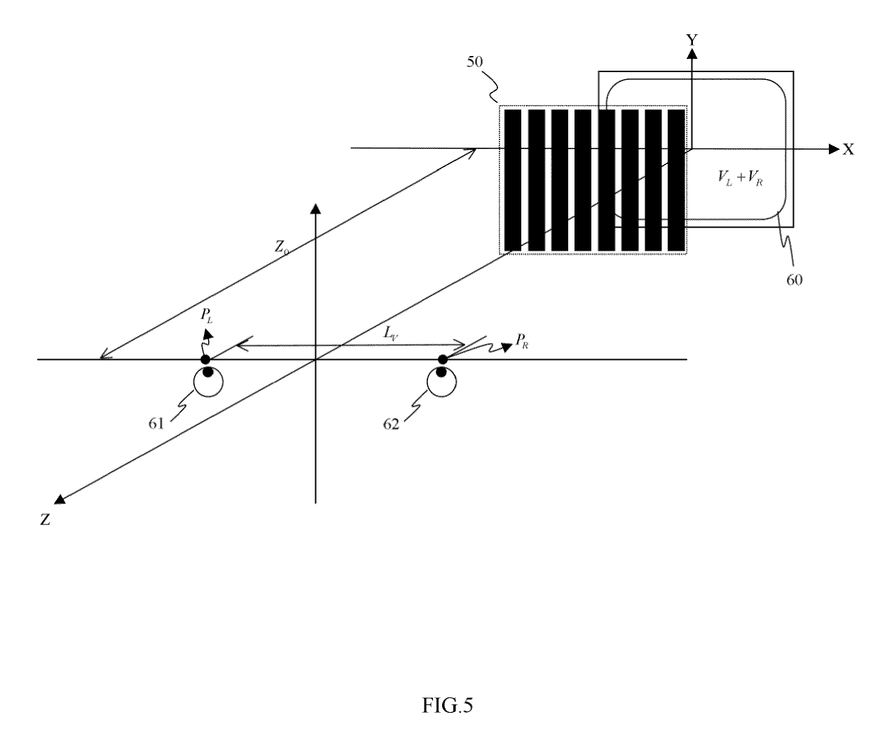

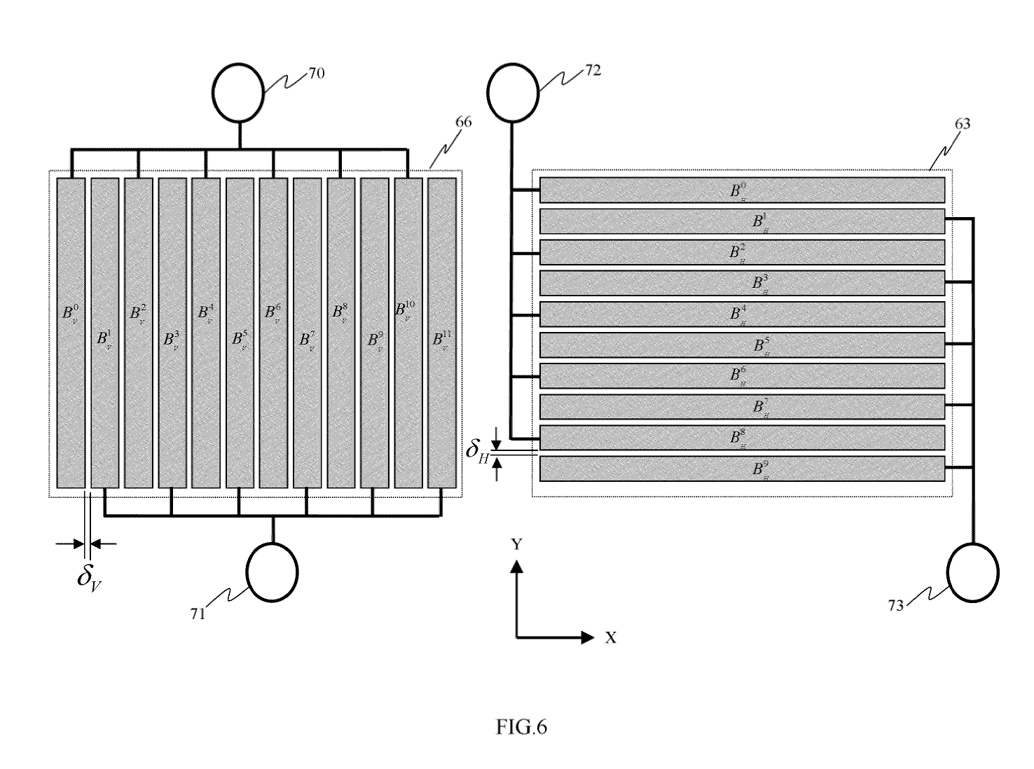

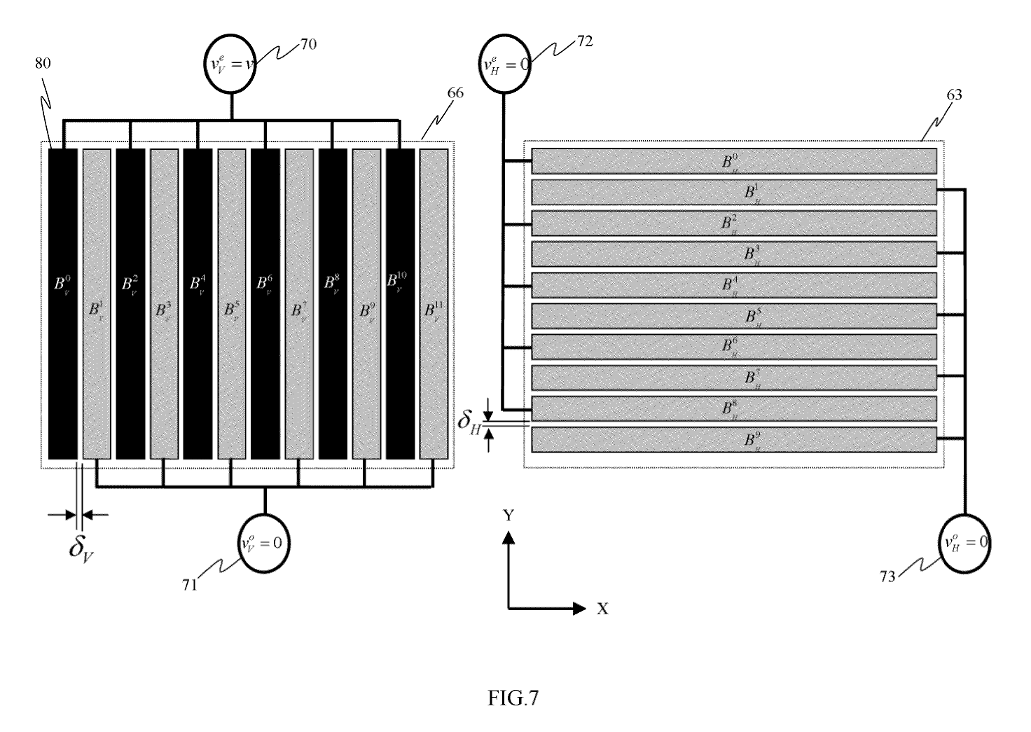

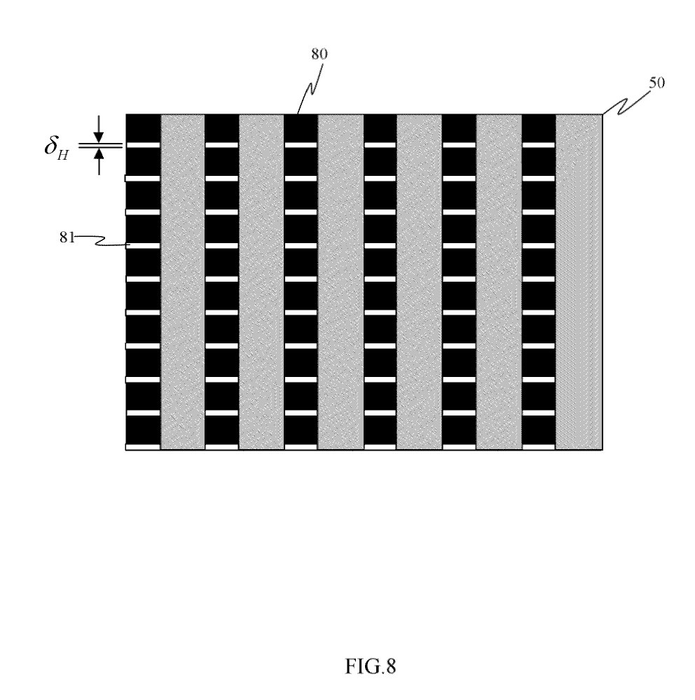

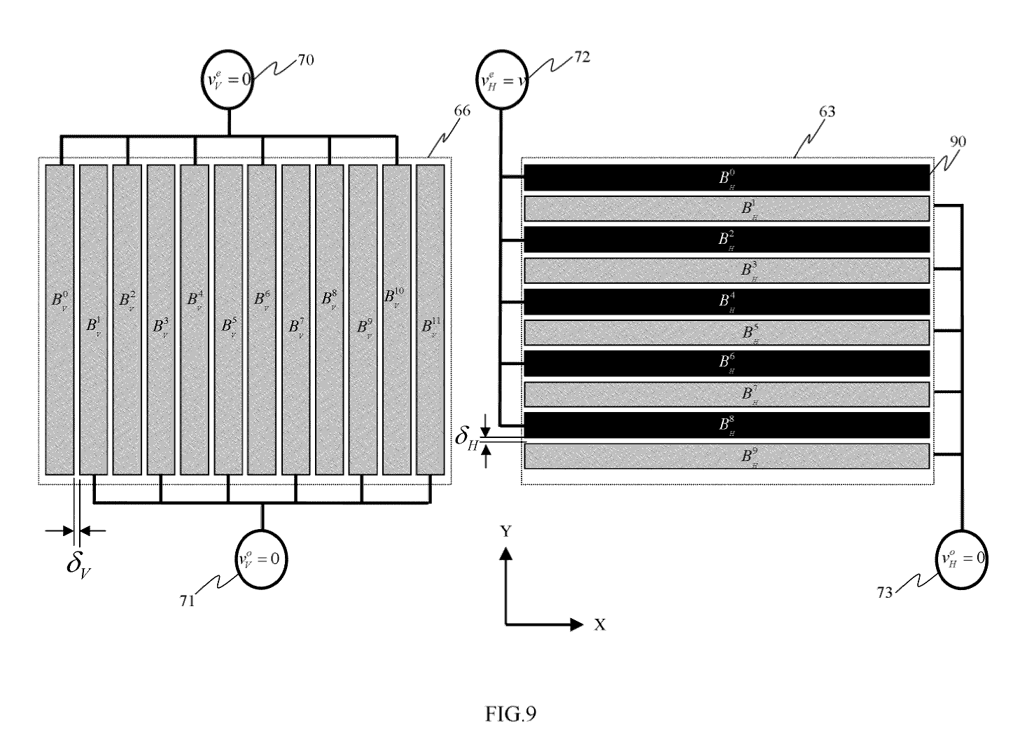

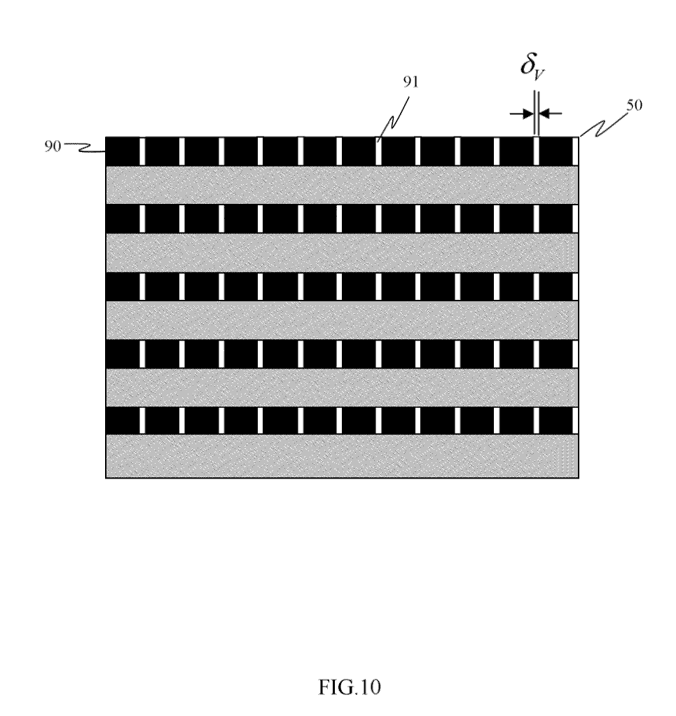

### DETAILED DESCRIPTION OF THE INVENTION

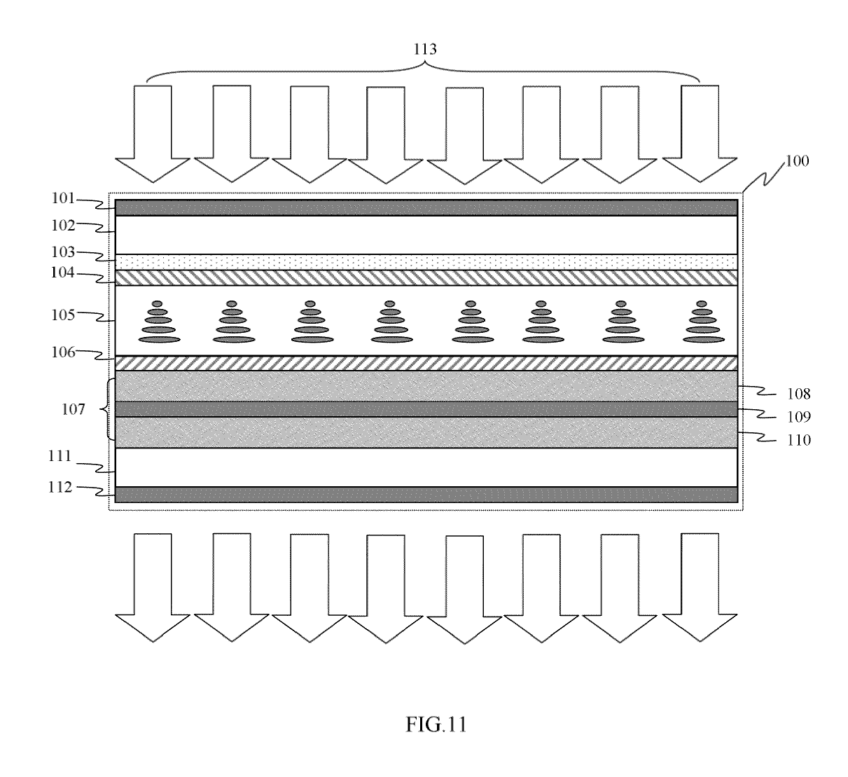

FIG. 11 is a schematic view of consisting of a multi-functional liquid crystal parallax barrier device according to a first embodiment of the present invention. As shown in FIG. 11, the multi-functional liquid crystal parallax barrier device 100 mainly includes an upper linear polarizer 101, an upper transparent substrate 102, a common electrode layer 103, an upper alignment layer 104, a liquid crystal molecular layer 105, a lower alignment layer 106, a pair of barrier electrode layers 107, a lower transparent substrate 111, and a lower linear polarizer 112. The upper linear polarizer 101, the upper transparent substrate 102, the common electrode layer 103, the upper alignment layer 104, the liquid crystal molecular layer 105, the lower alignment layer 106, the lower transparent substrate 111, and the lower linear polarizer 112 have the same structure and effect as the liquid crystal parallax barrier in the prior art, so the details will not be repeated herein. The pair of barrier electrode layers 107 are disposed on the lower transparent substrate 111 and are formed by two barrier electrode layers 108, 110 and an insulation layer 109. The insulation layer 109 electrically isolates the two barrier electrode layers 108, 110 to avoid an electrical short circuit between the two barrier electrode layers.

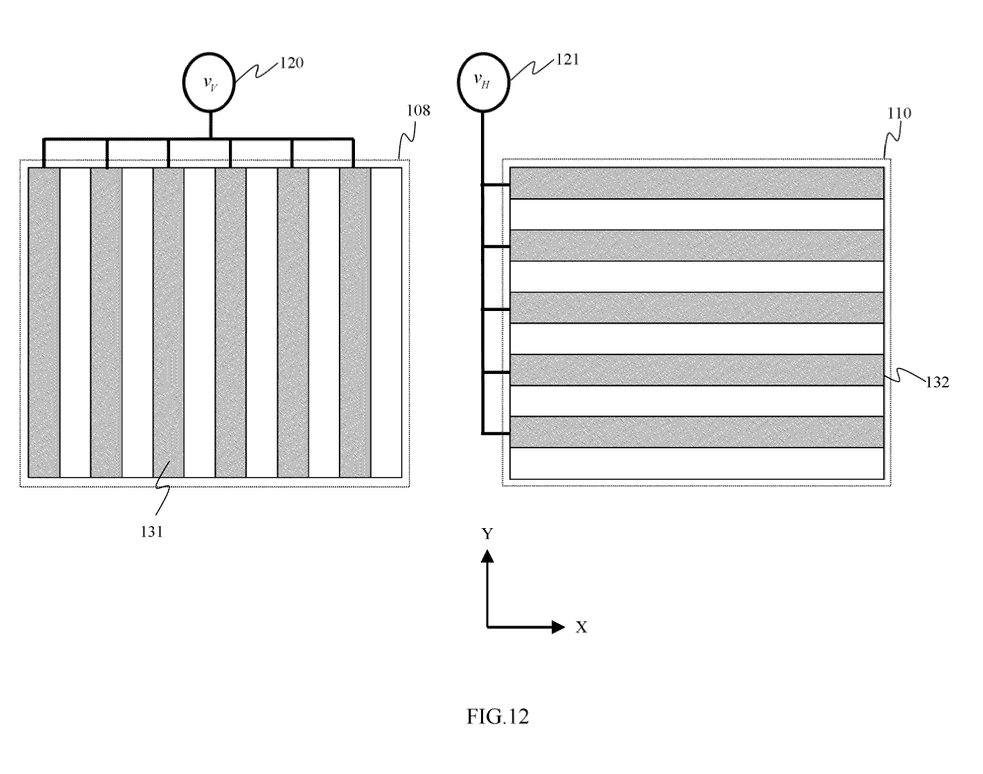

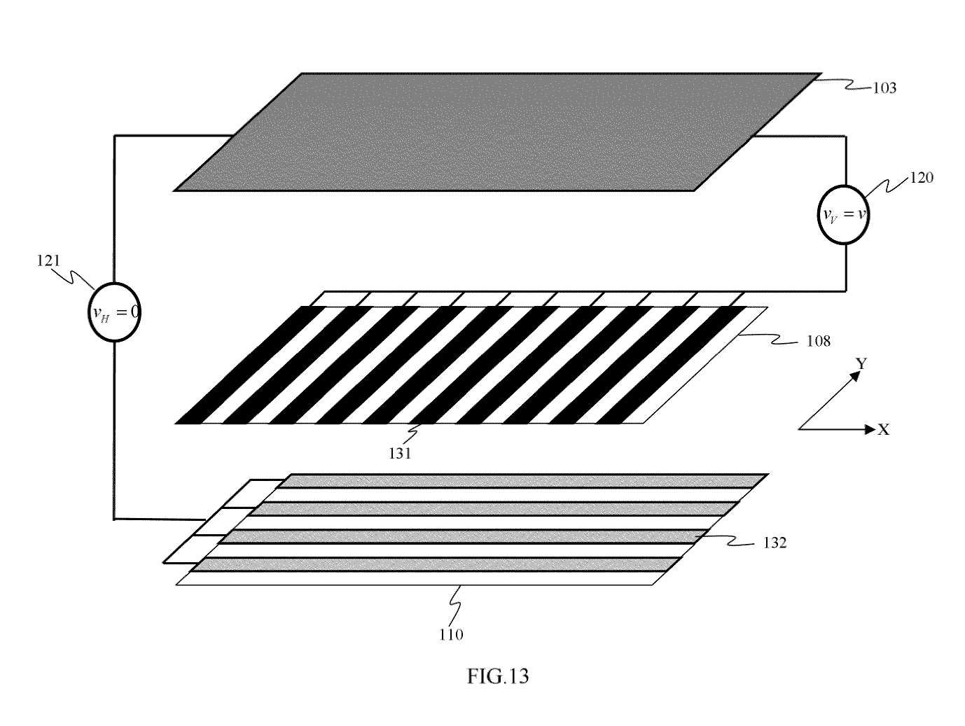

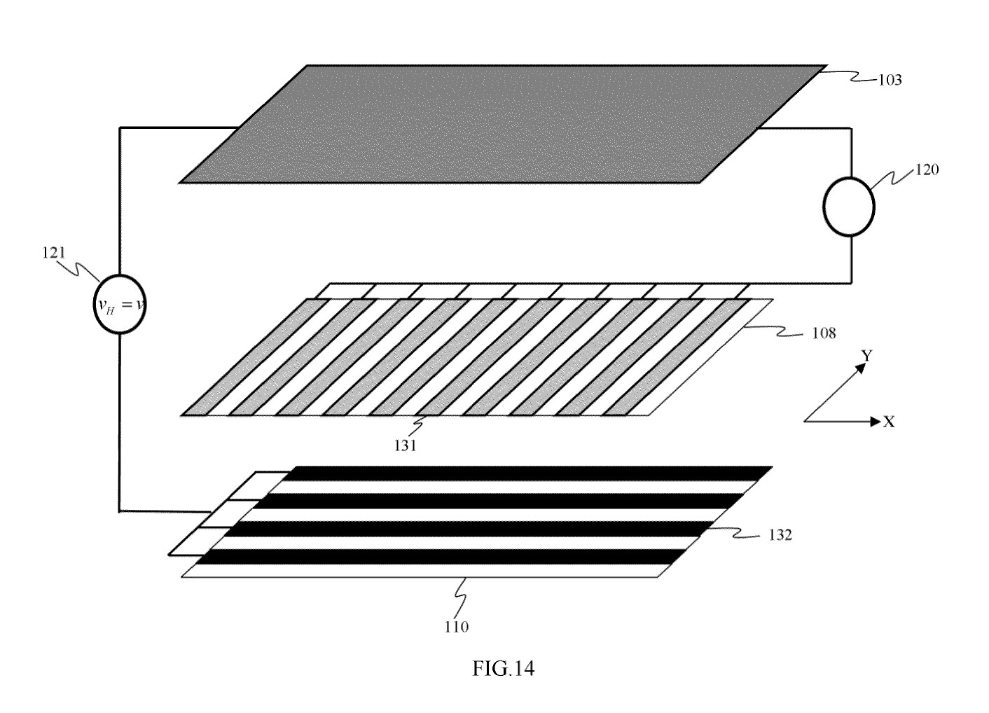

As shown in FIG. 12, the two barrier electrode layers are formed by an upper barrier electrode layer 108 and a lower barrier electrode layer 110. The upper barrier electrode layer 108 is installed with a plurality of longitudinal electrodes 131, and all the longitudinal electrodes 131 are electrically connected and then connected to a longitudinal power source 120. The lower barrier electrode layer 110 is installed with a plurality of transverse electrodes 132, and all the transverse electrodes 132 are electrically connected and then connected to a transverse power source 121. The longitudinal electrode 131 and the transverse electrode 132 have an orthogonal geometric relation, that is, have a relation of rotating by 90° relative to each other. As shown in FIG. 13, when the longitudinal power source 120 outputs a driving voltage ν_{V}=ν and the transverse power source 121 outputs a driving voltage ν_{H}=0, the longitudinal electrode 131 produces a longitudinal barrier effect. As shown in FIG. 14, when the transverse power source 121 outputs a driving voltage ν_{H}=ν and the longitudinal power source 120 is in an open circuit state, the transverse electrode 132 produces a transverse barrier effect. Since the common electrode in the present invention is a complete electrode plane, no light-transmissive gap is generated.

### Second Embodiment

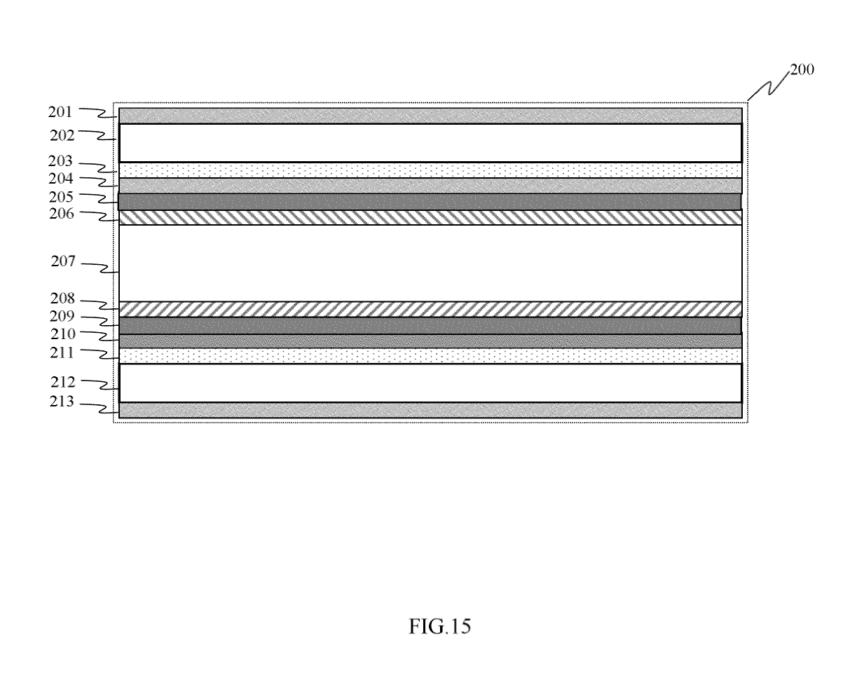

FIG. 15 is a schematic view of consisting of a multi-functional liquid crystal parallax barrier device according to a second embodiment of the present invention. As shown in FIG. 15, the multi-functional liquid crystal parallax barrier device 200 mainly includes an upper linear polarizer 201, an upper transparent substrate 202, an upper common electrode layer 203, an upper insulation layer 204, an upper barrier electrode layer 205, an upper alignment layer 206, a liquid crystal molecular layer 207, a lower alignment layer 208, a lower barrier electrode layer 209, a lower insulation layer 210, a lower common electrode layer 211, a lower transparent substrate 212, and a lower linear polarizer 213. The second embodiment has completely the same effect as the first embodiment, except that the upper barrier electrode layer 205 and the lower barrier electrode layer 209 of the second embodiment are respectively disposed on different transparent substrates. In addition, to achieve the voltage driving of the upper and lower electrodes, a common electrode layer and an insulation layer are added.

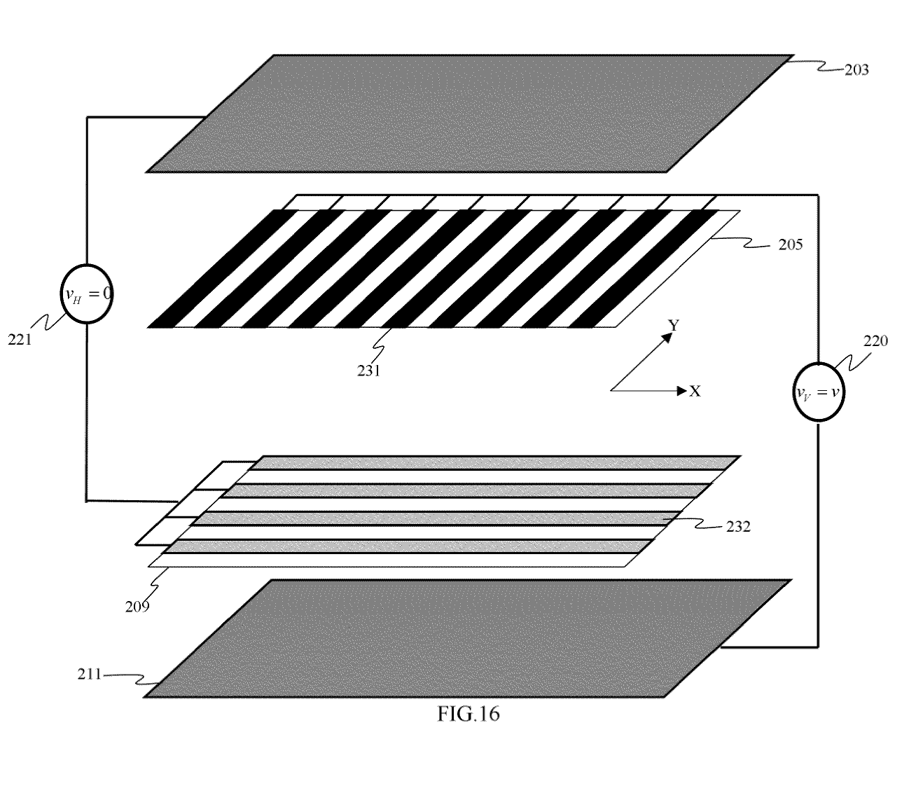

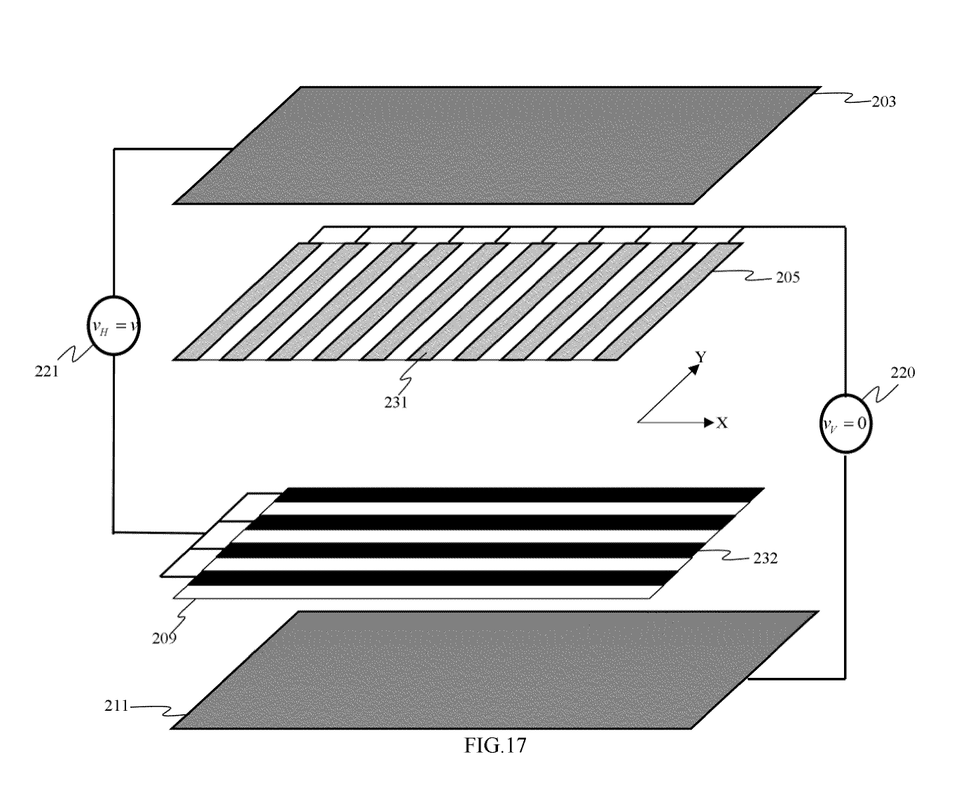

As shown in FIG. 16, the upper barrier electrode layer 205 is installed with a plurality of longitudinal electrodes 231, and all the longitudinal electrodes 231 are electrically connected and then connected to a longitudinal power source 220. The lower barrier electrode layer 209 is installed with a plurality of transverse electrodes 232, and all the transverse electrodes 232 are electrically connected and then connected to a transverse power source 221. The longitudinal electrodes 231 and the transverse electrodes 232 have an orthogonal geometric relation, that is, have a relation of rotating by 90° relative to each other. In addition, when the longitudinal power source 220 outputs a driving voltage ν_{V}=ν and the transverse power source 221 outputs a driving voltage ν_{H}=0, the longitudinal electrode 231 produces a longitudinal barrier effect. As shown in FIG. 17, when the transverse power source 221 outputs a driving voltage ν_{H}=ν and the longitudinal power source 120 outputs a driving voltage ν_{V}=0, the transverse electrode 232 produces a transverse barrier effect. Since the common electrode applied in the present invention is a complete electrode plane, no light-transmissive gap is generated.

In view of the above, to avoid generating the light-transmissive gap in the liquid crystal parallax barrier capable of bi-directionally displaying the 3D image in the prior art, the multi-functional liquid crystal parallax barrier device of the present invention mainly provides a structure of two independent barrier electrode layers and two complete common electrode layers, to completely solve the problem of the light-transmissive gap, thereby achieving the purpose of bi-directionally displaying the 3D image.

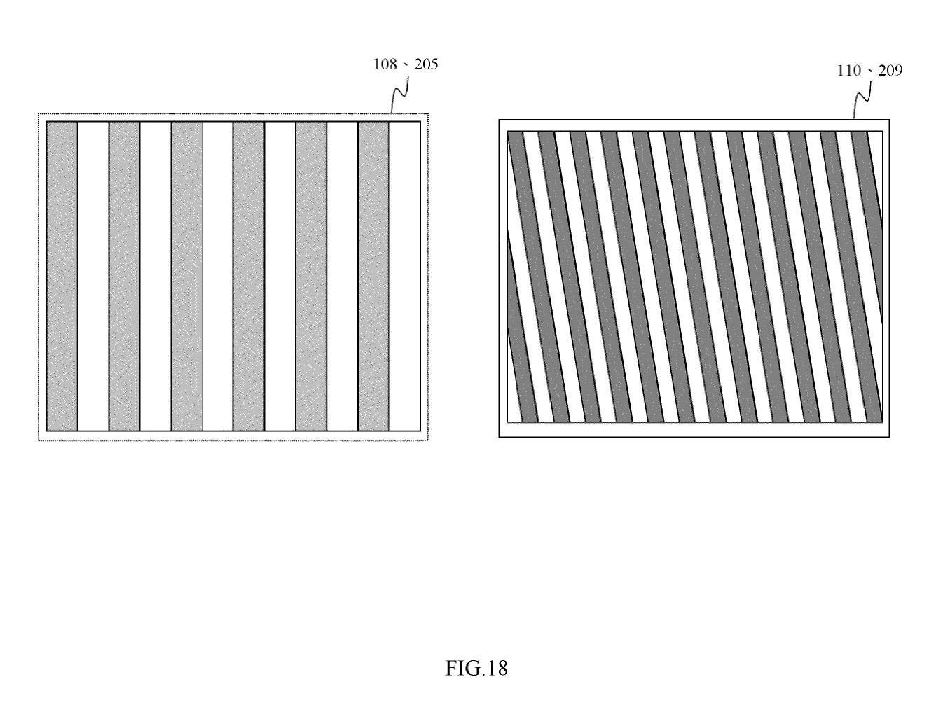

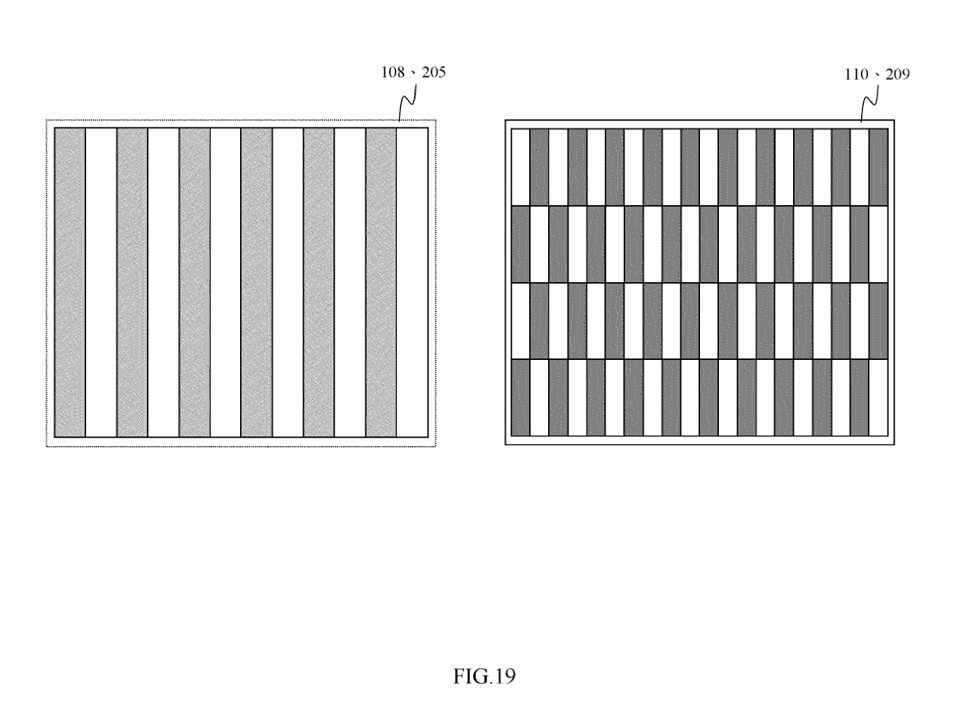

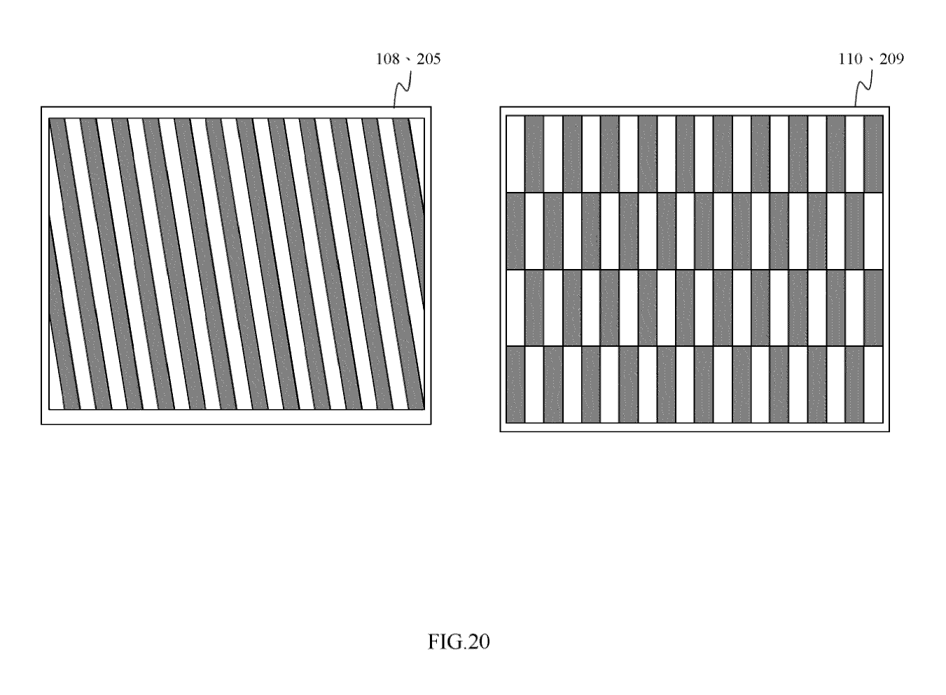

In addition, although the vertical strip parallax barrier is taken as an example for illustration in the above embodiments and drawings of the present invention, the upper barrier electrode layer and the lower barrier electrode layer may be installed with an electrode having a slant-and-strip parallax barrier or a slant-and-step parallax barrier structure. That is to say, the electrodes on the upper barrier electrode layer and the lower barrier electrode layer may be respectively formed by a vertical strip parallax barrier structure, a slant-and-strip parallax barrier structure, or a slant-and-step parallax barrier structure. As shown in FIG. 18, the upper barrier electrode layers 108, 205 are installed with the electrode having the vertical strip parallax barrier structure; and the lower barrier electrode layers 110, 209 are installed with the electrode having the slant-and-strip parallax barrier structure. As shown in FIG. 19, the upper barrier electrode layers 108, 205 are installed with the electrode having the vertical strip parallax barrier structure; and the lower barrier electrode layers 110, 209 are installed with the electrode having the slant-and-step parallax barrier structure. As shown in FIG. 20, the upper barrier electrode layers 108, 205 are installed with the electrode having the slant-and-strip parallax barrier structure; and the lower barrier electrode layers 110, 209 are installed with the electrode having the slant-and-step parallax barrier structure. Therefore, the present invention may achieve the purpose of displaying the 3D image with different barrier structures.

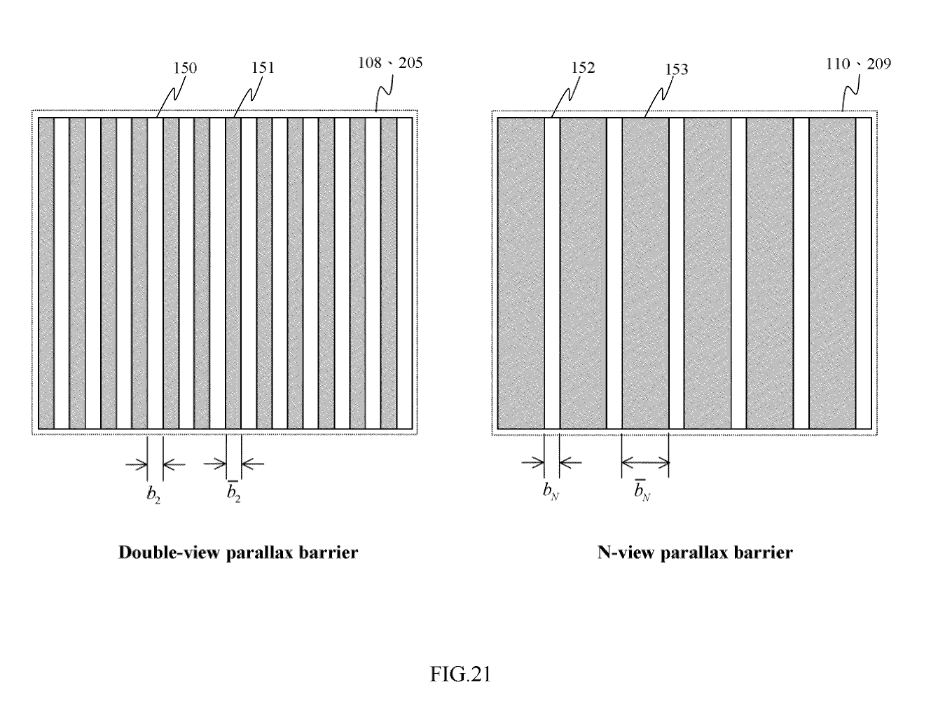

Furthermore, the electrode structures on the upper barrier electrode layer and the lower barrier electrode layer are designed with different numbers of views, thereby achieving the purpose of displaying the 3D image with different numbers of views. Hereinafter, for the simplicity of the drawings, the vertical strip parallax barrier is taken as an example to illustrate the barrier structure with different numbers of views. As shown in FIG. 21, the upper barrier electrode layers 108, 205 are installed with an electrode structure capable of display two views (referred to as a double-view parallax barrier hereinafter), and the lower barrier electrode layers 110, 209 are installed with an electrode structure capable of displaying N views (referred to as an N-view parallax barrier hereinafter), where N is a number of views greater than 2. ROC Patent Application No. 098128986 provides Formula (7) of the barrier design, in which for the double-view parallax barrier, the width b₂ of the light-transmissive element 150 and the width b̅₂ of the shielding element 151 have the relation of b̅₂=b₂; while for the N-view parallax barrier, the width b_{N} of the light-transmissive element 152 and the width b̅_{N} of the shielding element 153 have the relation of b̅_{N}=(N−1)b_{N}. Definitely, the widths of the light-transmissive element and the shielding element may also be calculated according to Formulas (20) and (21) in the patent. Therefore, the electrode structures on the upper barrier electrode layer and the lower barrier electrode layer may be designed based on displaying with different numbers of views, so the present invention may achieve the purpose of displaying the 3D image with different numbers of views.

What is claimed is:

1. A multi-functional liquid crystal parallax barrier device, functioning as a device having a liquid crystal structure, for displaying a bi-directional 3D image through the control of an appropriate driving voltage, and displaying a 3D image with different barrier structures and with different numbers of views.

2. The multi-functional liquid crystal parallax barrier device according to claim 1, wherein the device having the liquid crystal structure comprises an upper linear polarizer, an upper transparent substrate, a common electrode layer, an upper alignment layer, a liquid crystal molecular layer, a lower alignment layer, a pair of barrier electrode layers, a lower transparent substrate, and a lower linear polarizer.

3. The multi-functional liquid crystal parallax barrier device according to claim 2, wherein the pair of barrier electrode layers comprise an upper barrier electrode layer, a lower barrier electrode layer, and an insulation layer, and the insulation layer electrically isolates the upper barrier electrode layer from the lower barrier electrode layer to avoid an electrical short circuit between the two barrier electrode layers.

4. The multi-functional liquid crystal parallax barrier device according to claim 3, wherein the upper barrier electrode layer and the lower barrier electrode layer are respectively installed with a plurality of electrodes.

5. The multi-functional liquid crystal parallax barrier device according to claim 4, wherein the electrodes on the upper barrier electrode layer and the lower barrier electrode layer are controlled by the driving voltage to shield or allow light to penetrate.

6. The multi-functional liquid crystal parallax barrier device according to claim 4, wherein the electrodes on the upper barrier electrode layer and the lower barrier electrode layer are respectively formed by a vertical strip parallax barrier structure, a slant-and-strip parallax barrier structure, or a slant-and-step parallax barrier structure.

7. The multi-functional liquid crystal parallax barrier device according to claim 4, wherein the electrodes on the upper barrier electrode layer and the lower barrier electrode layer have a relation of rotating by 90° relative to each other, so as to generate functions of a longitudinal barrier and a transverse barrier.

8. The multi-functional liquid crystal parallax barrier device according to claim 4, wherein the electrodes on the upper barrier electrode layer and the lower barrier electrode layer respectively display a multi-view 3D image with an arbitrary number of views.

9. The multi-functional liquid crystal parallax barrier device according to claim 1, wherein the device having the liquid crystal structure comprises an upper linear polarizer, an upper transparent substrate, an upper common electrode layer, an upper insulation layer, an upper barrier electrode layer, an upper alignment layer, a liquid crystal molecular layer, a lower alignment layer, a lower barrier electrode layer, a lower insulation layer, a lower common electrode layer, a lower transparent substrate, and a lower linear polarizer.

10. The multi-functional liquid crystal parallax barrier device according to claim 9, wherein the upper barrier electrode layer and the lower barrier electrode layer are respectively installed with a plurality of electrodes.

11. The multi-functional liquid crystal parallax barrier device according to claim 10, wherein the electrodes on the upper barrier electrode layer and the lower barrier electrode layer are controlled by the driving voltage to shield or allow the light to penetrate.

12. The multi-functional liquid crystal parallax barrier device according to claim 10, wherein the electrodes on the upper barrier electrode layer and the lower barrier electrode layer are respectively formed by a vertical strip parallax barrier structure, a slant-and-strip parallax barrier structure, or a slant-and-step parallax barrier structure.

13. The multi-functional liquid crystal parallax barrier device according to claim 10, wherein the electrodes on the upper barrier electrode layer and the lower barrier electrode layer have a relation of rotating by 90° relative to each other, so as to generate functions of a longitudinal barrier and a transverse barrier.

14. The multi-functional liquid crystal parallax barrier device according to claim 10, wherein the electrodes on the upper barrier electrode layer and the lower barrier electrode layer respectively display a multi-view 3D image with an arbitrary number of views.
